(19) United States
(12) Patent Application Publication
(10) Pub. No.: US 2012/0244802 A1
(43) Pub. Date: Sep. 27, 2012

(54) ON CHIP INDUCTOR

(76) Inventors: Lei Feng, Hillsboro, OR (US); Yaron Peperovits, Hillsboro, OR (US)

(21) Appl. No.: 13/070,645

(22) Filed: Mar. 24, 2011

(51) Int. Cl. H04B 5/00; H01F 41/00; H01F 27/28

(52) U.S. Cl. 455/41.1; 336/225; 29/602.1

(57) ABSTRACT

An apparatus may comprise a pair of inductors in an integrated circuit. Other embodiments are described and claimed.

### BACKGROUND

On-chip inductors are widely used in integrated circuit design. Inductors can be used for different purposes such as to tune transceivers at different frequencies to support several bands, or can be placed at different positions for filtering, blocking etc. Integrated circuits (IC's) are known to include a substrate, one or more dielectric layers on the substrate, and one or more metal layers supported by a corresponding dielectric layer. The metal layers are fabricated in such a way to produce on-chip components such as resistors, transistors, capacitors, inductors, et cetera. How an on-chip component such as an inductor is fabricated and the physical limits placed on on-chip components are dictated by the technology used and foundry rules governing such technology.

As the trend for integrating multiple systems into one die continues, more and more inductors are needed. However, several hurdles exist to integrating larger numbers of inductors in integrated circuits. In the first place, in many applications, such as in a wireless transceiver system, inductors usually occupy a large area, thus reducing available area for other devices, such as memory and processors. Furthermore, during operation, when current passes along the conductive path of an inductor, magnetic fields are created that can couple into nearby devices. In order to operate properly, it is often desirable that coupling between inductors be minimized. To achieve low coupling between inductors (good isolation), the inductors require substantial spacing between one another, which places further constrains on chip layout. It is with respect to these and other considerations that the present improvements have been needed.

### BRIEF DESCRIPTION OF THE DRAWINGS

FIG. 1 illustrates one embodiment of an inductor arrangement.

FIGS. 2a and 2b illustrate exemplary magnetic fields in the inductor arrangement of FIG. 1.

FIG. 3 illustrates exemplary current flow in the inductor arrangement of FIG. 1.

FIG. 4a illustrates one embodiment of a multiwinding inductor arrangement.

FIG. 4b shows one inductor of the inductor arrangement of FIG. 4a.

FIG. 4c shows another inductor of the inductor arrangement of FIG. 4a.

FIG. 5a illustrates another embodiment of a multiwinding inductor arrangement.

FIG. 5b shows one inductor of the inductor arrangement of FIG. 5a.

FIG. 5c shows another inductor of the inductor arrangement of FIG. 5a.

FIG. 6 illustrates one embodiment of a computing system.

FIG. 7 illustrates one embodiment of a communications system.

### DETAILED DESCRIPTION

Various embodiments may be generally directed to systems that employ on-chip inductors. Some embodiments may be particularly directed to architecture for on-chip inductors.

As on-chip inductors become more widely deployed in integrated circuits, an arrangement to reduce the space occupied by inductors may be desirable. Various embodiments provide compact inductor arrangements in which a multiplicity of inductors can be disposed in an integrated circuit in close proximity.

In some embodiments, an inductor architecture for use in an integrated circuit chip comprises a first inductor that occupies a first area of the integrated circuit chip and one or more additional inductors that also are arranged to occupy the first area. In accordance with various embodiments, the planar area (or, chip real estate) occupied by a multiplicity of inductors is reduced as compared to known designs.

In some embodiments, a pair of inductors are arranged to occupy the same chip real estate thereby reducing the total area in a substrate used by the inductors as compared to designs in which the inductors each occupy separate areas.

In various embodiments a first inductor is arranged as a rectangular, octagonal, circular, elliptical or other shape. The first inductor may be arranged to occupy a first area of a substrate, such as an integrated circuit. The term “occupy an area” as used herein, refers to a planar area of a substrate generally defined by the outer edges of the inductor. Thus, a rectangular inductor comprising a metallic path formed in the shape of the edges of a rectangle may be deemed to occupy an area equal to the width times height of the rectangle formed by the inductor, even though the interior of the rectangle may be unoccupied by the metal of the rectangular inductor.

In accordance with various embodiments, a second inductor is arranged to occupy at least a portion of the area occupied by the first inductor. In some embodiments the second inductor comprises a crossing shape in which an electrically conductive continuous path forms a plurality of loops in which the path crosses over itself.

In accordance with various embodiments, a second inductor arranged with a crossing shape is disposed within the area occupied by a first inductor in a manner that causes cancellation of magnetic fields generated by current passing through the inductors. In this way, magnetic field coupling of the first and second inductors may be minimized. In some embodiments, the shape and placement of the crossing-shape inductor with respect to the first inductor is arranged to minimize electrical current coupling.

Various embodiments may comprise one or more elements. An element may comprise any structure arranged to perform certain operations. Although an embodiment may be described with a limited number of elements in a certain arrangement by way of example, the embodiment may include more or less elements in alternate arrangement as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

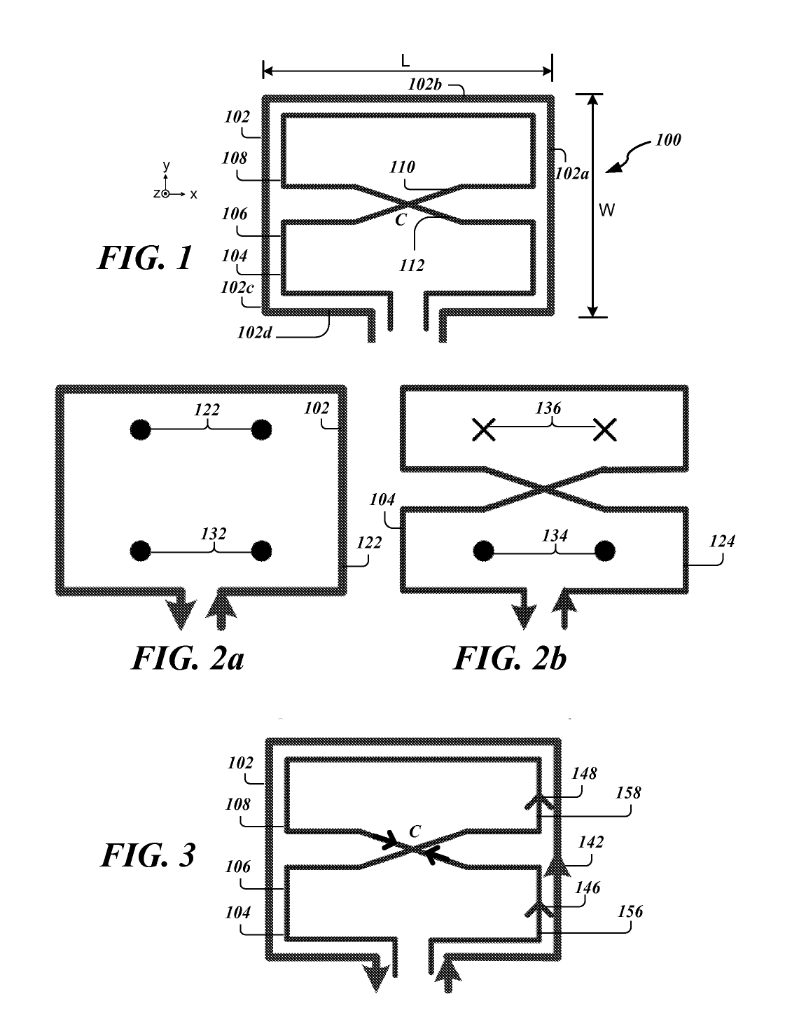

FIG. 1 depicts an inductor arrangement 100 in accordance with some embodiments. In this arrangement, a rectangular shaped inductor 102 surrounds a 8-shaped inductor 104. The rectangular inductor occupies an area equivalent to the length 1 and width W of the rectangle formed by the sides 102a-d of inductor 102. In various embodiments, the rectangular inductor may be formed in a substrate, such as an integrated circuit chip according to known processes. In some embodiments, the inductors 102, 104 may be formed using thick metal in order to improve the Q factor, which may be defined as the ratio of inductive reactance to the electrical resistance of the inductor.

In the arrangement of FIG. 1, the 8-shaped inductor includes two loops 106 and 108, which form a single continuous electrically conductive path. In order to form a single continuous electrical path, in the regions where the loops cross at point C, a first segment 110 of the inductor 104 is formed at a different height, or level, (coming out of the plane of the image in the z-direction) than a second segment 112. In some embodiments, all portions of inductor 104 may be formed at a first level in a substrate except for segment 110 (or, alternatively, except for segment 112), which segment may be formed at a second level. Electrically insulating material may be formed between segment 112 disposed in a first level and segment 110 disposed in a second level, thereby electrically isolating segments 110 and 112 from each other. By providing an 8-figure pattern in which a portion of one loop crosses over a portion of the other loop, inductor 104 reverses the electrical current path between loop 106 and 108 such that the current flows in a counterclockwise direction in one loop while flowing in a clockwise direction in the other, as discussed further below.

FIGS. 2a and 2b depict exemplary electrical current flow patterns and magnetic field patterns for inductors 102 and 104 of FIG. 1. In accordance with various embodiments, inductors 102 and 104 may be arranged to receive current through either side of the respective inductors. For the purposes of illustration, in FIGS. 2a, 2b current is shown flowing through the same side of each respective inductor, for example, the right side. Accordingly, when current is flowing in the inductors the direction of current flow may be the same in the lower right portions 122, 124 of respective inductors 102, 104.

As illustrated in FIG. 2a, current may flow around the rectangular inductor 102 in a counterclockwise direction. The magnetic fields 132 that are induced by the current flow in inductor 102 are out of the plane of the substrate, as illustrated.

FIG. 2b depicts an example in which the direction of current flow in lower loop 106 is counterclockwise; accordingly, the direction of current flow in upper loop 108 is clockwise. In this manner, the induced magnetic field 134 is out of the substrate plane in the region of lower loop 106, while the induced magnetic field 136 is into the substrate plane in the region of upper loop 108. This arrangement may provide magnetic field cancellation in the following manner. First, the magnetic coupling from inductor 102 to 104 may be considered. The current flowing through inductor 102 shown in FIG. 2a generates magnetic fields 122 and 132. The magnetic field 122 induces counterclockwise current in upper loop 108 of inductor 104, while the magnetic field 132 induces a counterclockwise current in lower loop 106 of inductor 104. In some embodiments, these two opposing currents may result in an overall zero current in inductor 104. Accordingly, there is no magnetic coupling from 102 to 104 in some embodiments. Second, the magnetic coupling from inductor 104 to 102 may be considered. The current flowing through inductor 104 shown in FIG. 2b generates magnetic fields 136 and 134. The magnetic field 136 induces clockwise current in inductor 102, while the magnetic field 134 induces counterclockwise current in inductor 102, which may produce a zero overall induced current in the inductor 102 in some embodiments. Therefore, the magnetic coupling from 104 to 102 is zero according to some embodiments.

In some embodiments, the shape and mutual placement of both inductors may be arranged to minimize the magnetic coupling. For example, in some embodiments inductor 104 may be arranged so that upper and lower portions 106 and 108 are the same size and shape. Inductor 104 may also be placed symmetrically within the area defined by inductor 102 such that left and right portions of inductor 104 are equally spaced from left and right portions of inductor 102, and upper and lower loops 106 and 108 are equally spaced from upper and lower portions of inductor 102.

FIG. 3 depicts exemplary electrical current coupling between the inductors 102 and 104 of FIG. 1. In one example, an electrical current 142 in inductor 102 may induce in inductor 104 two parallel electrical currents 146 and 148 along the right edge portions 156 and 158 of lower loop 106 and upper loop 108, respectively. Although currents 146 and 148 are parallel to one another along the right side of inductor 104, the currents may oppose each other as they propagate through respective lower and upper loops 106 and 108, for example, in the region of crossing point C. Accordingly, the net current induced in inductor 104 may be zero or may be substantially reduced as compared to a configuration in which an inner inductor were shaped similarly to outer inductor 102.

Likewise, when current is flowing in inductor 104, the magnetic field of the upper loop 106 may induce a clockwise current in inductor 102, while the current flowing in the lower loop 104 may induce counterclockwise current in the inductor 102 which tends to cancel the clockwise current.

In some embodiments, the shape, size, and positioning of upper and lower loops 106, 108 may be arranged so that no net current is induced in inductor 104 when current flows in inductor 102 no net current is induced in inductor 102 when current flows in inductor 104.

In some embodiments, the shape of an inductor, such as an 8-figure inductor, may be arranged to provide only partial cancellation of magnetic and/or electrical coupling between inductors. In one example, the upper and lower loop portions of the 8-figure inductor may have different sizes. In another example, the 8-figure inductor may be arranged such that one loop is closer than the other loop to an outer inductor.

In various other embodiments, the shape of a first inductor may be circular, elliptical, octagonal, or other shape. The shape of each loop of an 8-shaped inductor may also vary according to various embodiments. For example each loop may have a circular shape, elliptical shape, octagonal shape, or other polygonal shape.

In various embodiments, a pair of inductors may be arranged similarly to the arrangement 100 depicted in FIG. 1, in which one or more of the inductors are formed using multiple windings (turns) within a single inductor, such that multiple windings in a given inductor each have the same general shape. In various embodiments, the windings in an inductor may all be disposed within the same plane. In some embodiments, an inductor similar in general shape to rectangular inductor 102 may comprise a series of windings that are concentric rectangular shapes that are electrically interconnected in series to form a single conductive path. In this manner, the inductance of the inductor can be increased over a similar inductor comprising a single rectangular path. In various other embodiments, an 8-shaped inductor similar in general shape to inductor 104 may comprise multiple figures of 8 that are electrically interconnected in series to form a single conductive path. I

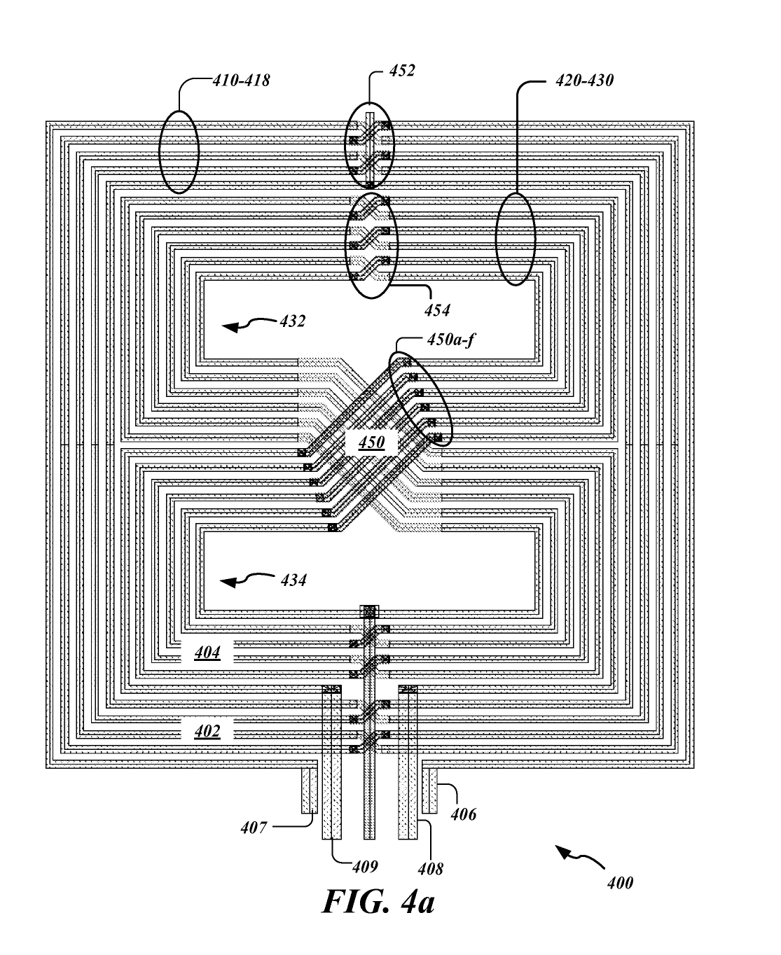

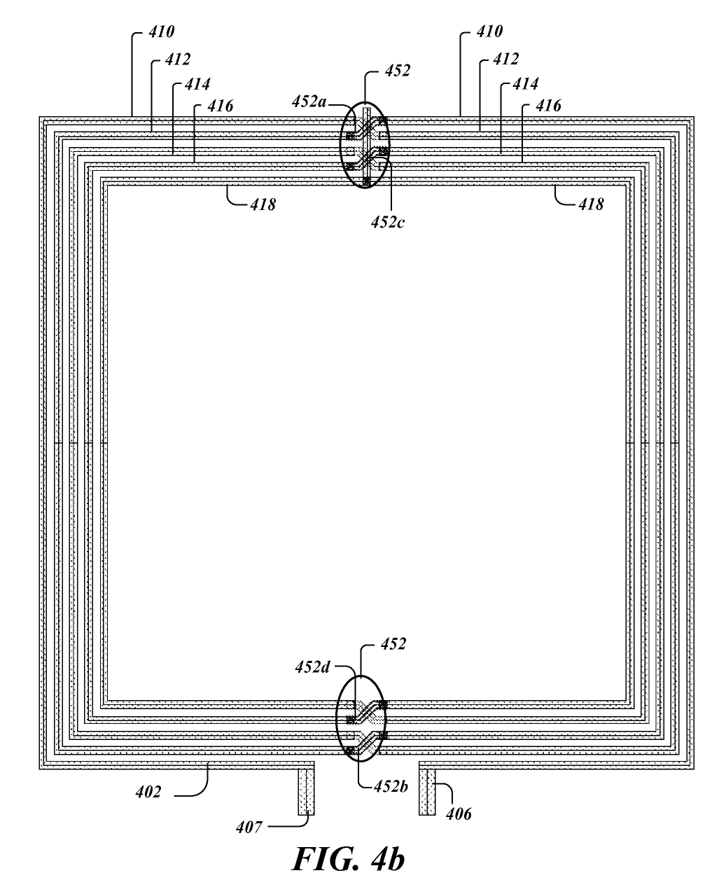

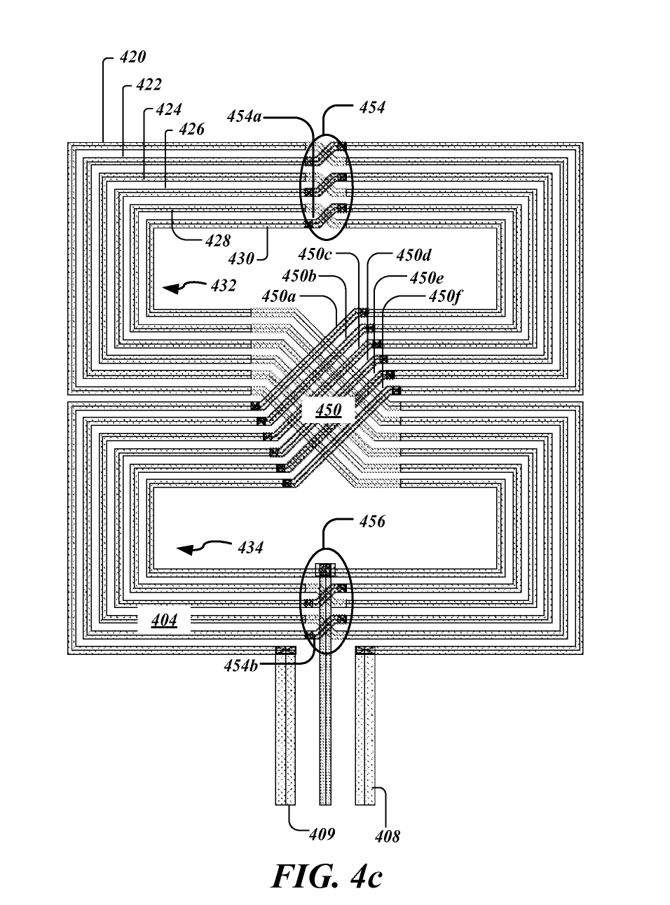

In some embodiments, both a rectangular inductor and an 8-shaped inductor may comprise multiple windings that are similarly shaped. FIG. 4a depicts one embodiment of an arrangement 400 of multiple winding inductors 402 and 404. FIGS. 4b and 4c depict the respective inductors 402 and 404 separately for clarity. Inductor 402 has a generally rectangular shape that includes a set of five concentric rectangles 410-418. Inductor 404 is disposed within the area defined by the innermost rectangle 418. Inductor 404 comprises six 8-figure shapes 420-430. As depicted, the overall upper 432 and lower 434 portions of inductor 404 are similar in shape and size. Accordingly, inductor arrangement 400 may provide minimum magnetic coupling between inductors 402 and 404. In this manner inductors 402, 404 may perform independently without mutual magnetic coupling in a manner similar to conventionally shaped inductors of similar size that are mutually separated by a substantial distance.

Accordingly, one advantage of arrangement 400 is that two high Q inductors that are effectively isolated from one another in operation can be formed in the same area (chip real estate) as conventionally occupied by a single inductor.

In addition to reducing the chip real estate occupied by the inductors, the arrangement 400 simplifies device layout considerations in an integrated circuit since the number of inductor sites may be reduced for the same number of inductors on a chip. This simplifies arrangement of other devices and circuits, since there are fewer spacing constraints dictated by the need to minimize magnetic coupling between nearby inductors. On the other hand, in some embodiments, using similar chip real estate as in a conventional inductor arrangement having single, isolated conductors, the number of inductors may be doubled without increasing magnetic coupling.

In some embodiments of multiwinding inductor layouts, such as that depicted in FIG. 4, both a rectangular inductor and an 8-shaped inductor may arranged in the same level of a substrate. For example, both inductors may be arranged in a metal layer designated M1, or M2 or similar designation. As with a single winding embodiment depicted in FIG. 1, a portion 450 of inductor 404 may be arranged in a different layer (substrate level) in order for crossing portions of each winding to be electrically isolated. This may be accomplished, for example, by conventional processing steps such as by providing conductive vertical vias (in the direction out of the plane) between one metal level and another. In one example, crossing segments 450a-f may be arranged on a level M2 while most other portions of inductors 402 and 404 are arranged on a level M1. Additionally, in order to provide a continuous electrical path in inductors 402 and 404, various crossover portions 452 and 454, 456 may be provided in different levels for inductors 402 and 404 respectively.

Notably, although square shaped inductor 402 may have numerous cross-over points, current received in an input to the inductor may propagate in a generally same direction (either counterclockwise or clockwise), unlike in what is termed herein a crossing-shaped inductor, such as an 8-figure inductor. For example, in the specific layout depicted in FIG. 4, inductor 402 is arranged as a series of interconnected rectangles 410-418 in which each full turn (corresponding to a complete rectangle) includes two inward crossovers. For example, in the first full turn, a first crossover 452a leads from right half of rectangle 410 to the left half of rectangle 412, and the second cross-over 452b leads from the left half of rectangle 412 to the right half of rectangle 414. Thus, in one complete turn, an input current travels from an outer rectangle 410 to a third-innermost rectangle 414, and in a second complete turn (via cross-overs 452c and 452d), to an innermost rectangle 418. Thence current travels in a series of turns that include two outward crossovers in each full turn from innermost rectangle 418 to outermost rectangle 410. In this manner, if the input current is received through the lower right input 406, the current travels initially in an inward counterclockwise spiral and subsequently in an outward counterclockwise spiral. Thus, current always flows in a common rotational direction, either counterclockwise or clockwise (if received at input 407).

In the case of inductor 404, current received at input (or node) 408 travels in a counterclockwise direction in each lower turn of loop 434 and in a clockwise direction in each upper turn of loop 432. Current received at input 409 travels in a clockwise direction in each lower turn of loop 434 and in a counterclockwise direction in each upper turn of loop 432. The inductor 404 illustrates on example of multiple 8-figure paths that are interconnected to form a single continuous electrical path. As illustrated, current entering inductor 404 at node 408 travels along an lower right portion of outermost loop 420 and continues into upper left portion of innermost loop 430, through cross-over 454a, into upper right portion of loop 428, lower left portion of loop 428, and through cross-over 454b and into lower right portion of loop 426. Thus, a single course through the outermost 8-loop path extends from outermost loop 430 to third outermost loop 426. This pattern generally continues as the path of inductor 404 winds inwardly and then outwardly to exit at node 409.

In this manner, no matter which of nodes 406, 407 is arranged as input to inductor 402 or which of nodes 408, 409 is arranged as an input to inductor 404, the patterns for first and second currents simultaneously traveling through inductors 402 and 404, respectively, produce magnetic fields that tend to cancel magnetic coupling between the inductors.

In various other embodiments, a generally rectangular shaped first inductor may comprise a spiral shape involving fewer crossovers. However, various other configurations are also possible for multiturn inductors. For example, each of a first and second inductor can comprise a greater or lesser number of turns/crossovers. In one embodiment, the 8-shaped inductor may be disposed on the outside with respect to a rectangular inductor. In other embodiments, a multiple turn rectangular inductor and 8-shaped inductor may be arranged in a manner that interleaves turns of the 8-shaped inductor with those of the rectangular inductor.

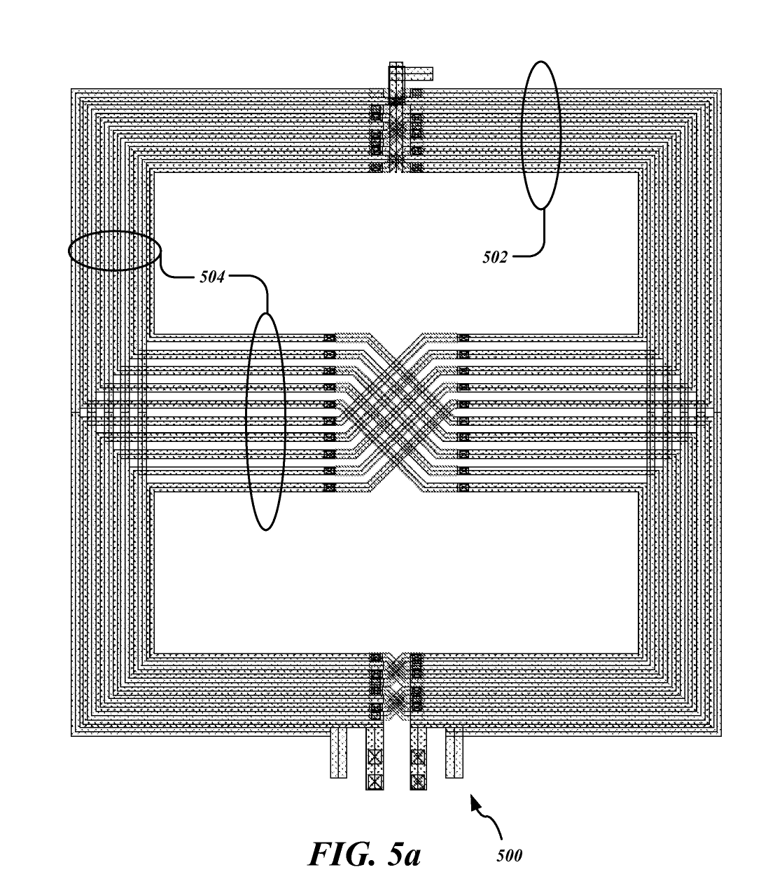

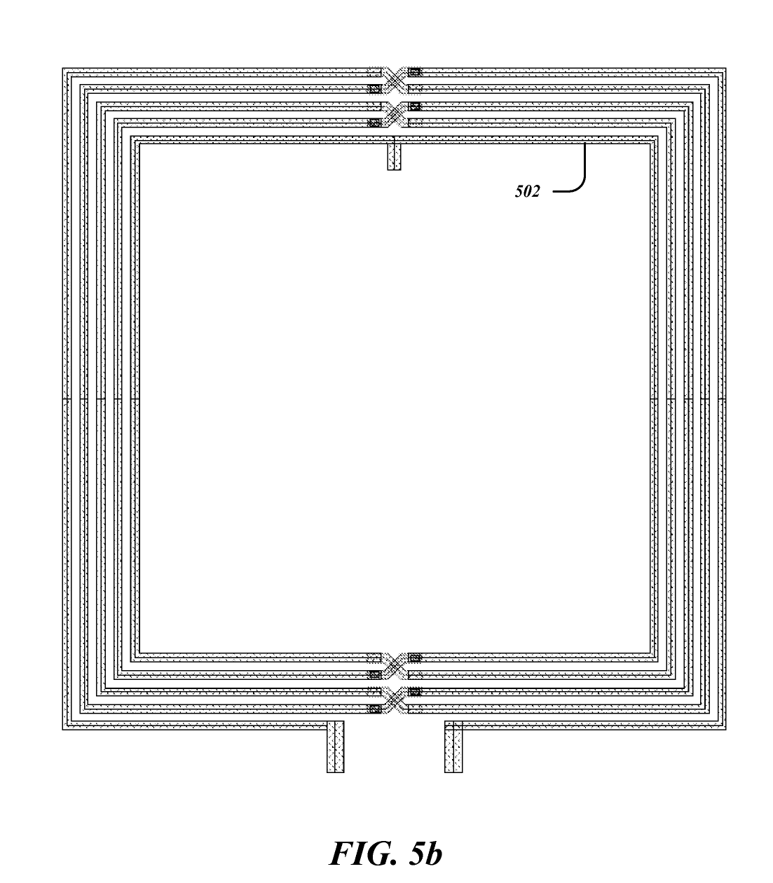

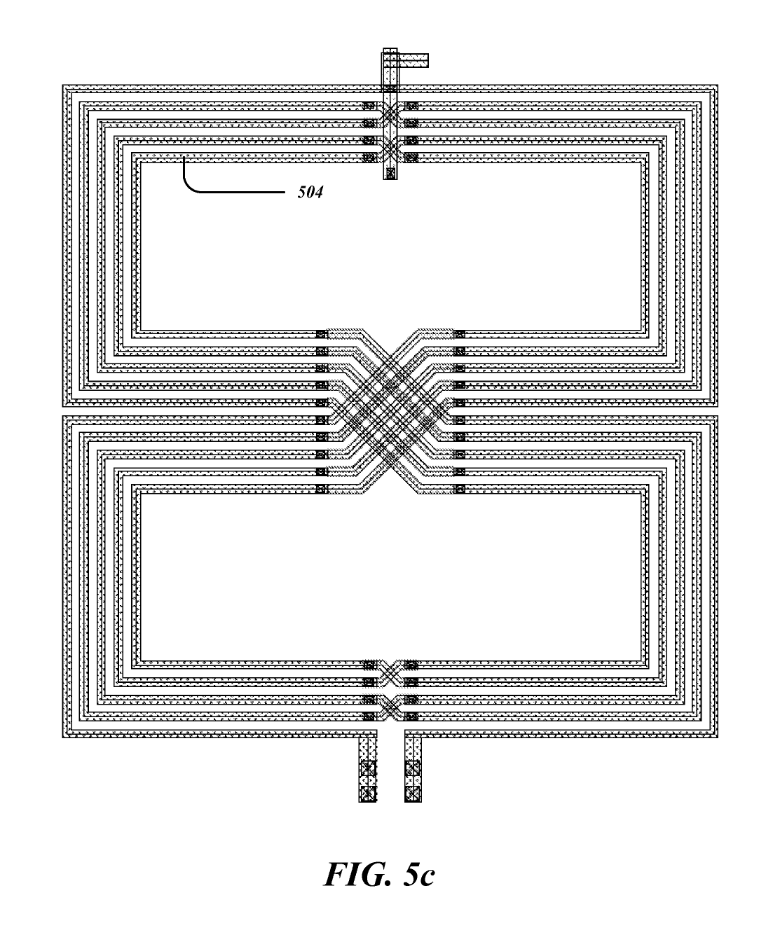

In some embodiments, a first inductor and a second inductor may occupy the same chip real estate while being disposed in different levels. FIG. 5a depicts one embodiment in which an inductor arrangement 500 includes a multiwinding rectangular inductor 502 that is located in a different layer than multiwinding 8-shaped inductor 504. FIGS. 5b and 5c depict the respective inductors 502 and 504 separately for clarity. As illustrated, in the plan view layout, the windings of inductor 502 overlap portions of the windings in inductor 504. However, because the inductors are disposed in separate levels, the inductors may be electrically insulated from one another using known processing techniques. As compared to the embodiment of FIG. 4, in this embodiment, assuming that inductors 402 and 502 are similar in size, the overall size of the 8-shaped inductor 504 may be larger than that of inductor 404. Therefore, the overall electrical path length may also be longer.

In some embodiments in which two different inductors are disposed in two different levels, the metal process used to form the inductors may differ. Thus, a first square shaped inductor generally disposed in level M1 (not shown) may be formed using metal having a first thickness, while a second 8-shaped inductor generally disposed in a level M2 (not shown) may be formed using a metal having a second thickness. This offers another degree of flexibility in inductor design since the desired Q factor of each inductor may be a function of metal thickness, length, linewidth, resistivity, and other factors.

Although embodiments disclosed above involve an 8-shaped inductor, other embodiments are possible in which other inductor shapes provide magnetic coupling cancellation and/or electrical coupling cancellation. In addition, embodiments in which more than two inductors are arranged within the same area are possible in which magnetic and/or electrical coupling cancellation is provided between the inductors. In various embodiments, if the magnetic fields generated by current passing through a first inductor induce overall zero current in a second inductor, the coupling from the first to the second inductor is zero. In one specific embodiment, another 8-shaped inductor may be added to the aforementioned dual inductor arrangements as a third inductor. The “extra” inductor may be rotated 90 degrees from the orientation of the first 8-shaped inductor. A fourth inductor may then be added to this three inductor arrangement in the form of an 8-shaped inductor rotated 45 degrees with respect to the other two 8-shaped inductors. In principle, more inductors could be arranged into a multi-inductor configuration that occupies the same chip real estate to the extent that enough metals are available for crossing. However, the extra inductor loss caused by parasitics may eventually increase to the point of inoperability. Accordingly, embodiments having more than three or four inductors in the same chip real estate may be less useful using currently available technology.

In various embodiments, the inductor arrangements may be implemented in integrated circuit technology, such as CMOS chips. In some embodiments, the design rule may include 90 nm technologies or even smaller design rules.

In some embodiments, the inductor architecture may be used in microprocessors and in wireless communication circuits, such as transceivers used for wireless data standards, such as as WiFi, WiMax and 3G-LTE.

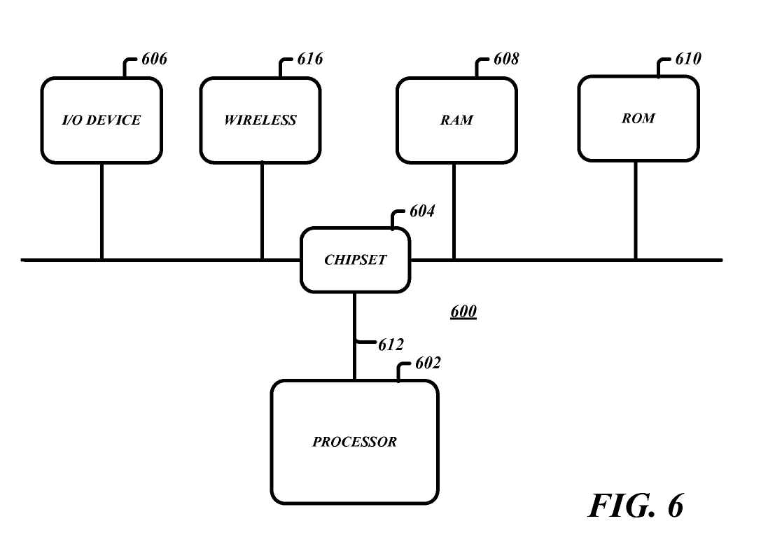

FIG. 6 is a diagram of an exemplary computing system embodiment. In particular, FIG. 6 is a diagram showing a system 600, which may include various elements. As shown in FIG. 6, I/O device 606, RAM 608, and ROM 610 are coupled to processor 602 by way of chipset 604. Chipset 604 may be coupled to processor 602 by a bus 612. Accordingly, bus 612 may include multiple lines. In various embodiments, system 600 may include a transceiver 616 that includes an inductor arrangement in accordance with the aforementioned embodiments. The embodiments, however, are not limited to these elements.

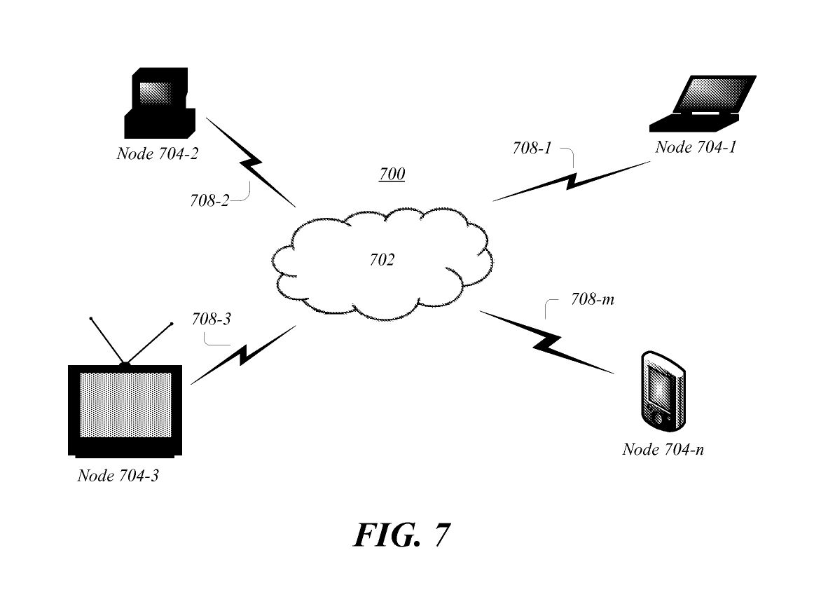

FIG. 7 illustrates a block diagram of one embodiment of a communications system 700 that may incorporate, for example the inductor architecture 100, 400, or 500. As shown in FIG. 7, the communications system 700 may comprise a network 702 that communicates over links 708-m with a plurality of nodes 704-n, where m and n may represent any positive integer value. In various embodiments, the nodes 704-n may be implemented as various types of wireless devices. Examples of wireless devices may include, without limitation, a station, a subscriber station, a base station, a wireless access point (AP), a wireless client device, a wireless station (STA), a laptop computer, ultra-laptop computer, portable computer, personal computer (PC), notebook PC, handheld computer, personal digital assistant (PDA), cellular telephone, combination cellular telephone/PDA, smartphone, pager, messaging device, media player, digital music player, set-top box (STB), appliance, workstation, user terminal, mobile unit, consumer electronics, television, digital television, high-definition television, television receiver, high-definition television receiver, and so forth.

In some embodiments, the nodes 704-n may comprise one more wireless interfaces and/or components for wireless communication such as one or more transmitters, receivers, transceivers, radios, chipsets, amplifiers, filters, control logic, network interface cards (NICs), antennas, antenna arrays, modules and so forth.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a first inductor arranged to occupy a first area of a substrate, the first inductor comprising a loop shape arranged to produce a first magnetic field; and
a second inductor disposed at least partially within the first area and comprises a crossing shape that includes a multiplicity of loops, wherein the multiplicity of loops are arranged to produce a second and a third magnetic field that cancel magnetic coupling between the first and second inductor.

2. The apparatus of claim 1, wherein the second inductor comprises an 8-shaped figure.

3. The apparatus of claim 2, wherein a first and a second loop portion of the 8-shaped figure are equal to one another.

4. The apparatus of claim 2, wherein the first loop portion of the 8-shaped figure differs from the second loop portion in at least one of: shape and size, wherein the first inductor and second inductor are partially magnetically coupled.

5. The apparatus of claim 1, wherein the first inductor comprises multiple concentric windings.

6. The apparatus of claim 5, wherein the multiple concentric windings are each arranged to conduct current received at an input of the first inductor in one of: a counterclockwise direction and a clockwise direction.

7. The apparatus of claim 1, wherein the second inductor comprises a multiplicity of 8-shaped loops, each 8-shaped loop having an upper and a lower loop, the upper loop being arranged to conduct current received from an input of the second inductor in one of a counterclockwise direction and a clockwise direction, and the lower loop being arranged to conduct current received from the input of the second inductor in the other of the clockwise and the counterclockwise direction.

8. The apparatus of claim 1, wherein the first inductor and second inductor group are disposed in a same level of the substrate.

9. The apparatus of claim 1, wherein the first inductor is disposed in a different level from that of the second inductor.

10. The apparatus of claim 9, wherein the first and second inductors are formed by a different metallurgical process.

11. The apparatus of claim 2, wherein a first and a second loop portion of the 8-shaped figure are arranged such that an overall electric coupling between the first and second inductors is zero.

12. The apparatus of claim 1, wherein the substrate comprises an integrated circuit.

13. A communications system, comprising:
a wireless transceiver disposed in an integrated circuit chip having a multiplicity of inductors, the multiplicity of inductors comprising one or more inductor pairs that comprise:
a first inductor that occupies a first area of the integrated circuit chip and is arranged to produce a first magnetic field; and
a second inductor that lies at least partially within the first area and comprises an 8-shape curve pattern that is arranged to produce opposing magnetic fields that at least partially cancel magnetic coupling between the first and second inductor.

14. The communications system of claim 13, wherein the first inductor comprises multiple concentric loops that are electrically connected in series to one another.

15. The communications system of claim 13, wherein the second inductor comprises a multiplicity of 8-shaped loops.

16. The communications system of claim 13, wherein the system comprises one or more of:
a wireless access point, a wireless client device, a wireless station, a laptop computer, ultra-laptop computer, portable computer (PC), personal computer, notebook PC, handheld computer, personal digital assistant (PDA), cellular telephone, combination cellular telephone/PDA, smartphone, pager, messaging device, media player, digital music player, set-top box, appliance, workstation, user terminal, mobile unit, consumer electronics, television, digital television, high-definition television, television receiver, and a high-definition television receiver.

17. The communications system of claim 17, wherein the first inductor is disposed in a first level and second inductor is disposed in a second level, and wherein the first and second inductors overlap one another.

18. A method of fabricating inductors in a substrate, comprising:
arranging a first inductor in a first level of the substrate, the first inductor occupying a first area and operable to provide a first magnetic field when current passes therethrough; and
arranging a second inductor over at least a portion of the first area of the substrate, the second inductor comprising an 8-figure shape having a first loop and a second loop mutually arranged to produce opposing magnetic fields that are operable to cancel magnetic coupling to the first magnetic field when a second current passes through the second inductor.

19. The method of claim 18, comprising arranging the second inductor in a second level of the substrate, wherein the first and the second inductor at least partially overlap one another.

20. The method of claim 18, wherein the first inductor comprises concentric multiple windings, and wherein the second inductor comprises multiple 8-shaped figures.
